(19) United States
(12) Patent Application Publication
(10) Pub. No.: US 2019/0258420 A1
(43) Pub. Date: Aug. 22, 2019

(54) MANAGING MULTI-TIERED SWAP SPACE

(71) Applicant: Jan Ralf Alexander OLDERDISSEN, Herrenberg (DE)

(72) Inventor: Jan Ralf Alexander OLDERDISSEN, Herrenberg (DE)

(73) Assignee: Nutanix, Inc., San Jose, CA (US)

(21) Appl. No.: 15/901,441

(22) Filed: Feb. 21, 2018

(51) Int. Cl. G06F 3/06

(52) U.S. Cl. CPC G06F 3/0647; G06F 3/0604; G06F 3/0659; G06F 3/0685; G06F 3/0632; G06F 3/0664

(57) ABSTRACT

Systems for enforcing virtualization quality-of-service policies to manage multi-tiered swap spaces. A method commences upon identifying a first storage area in a first data storage device of a first type and identifying a second storage area in a second data storage device of a second type. A swap space that comprises at least a portion of the first storage area and at least a portion of the second storage area is configured for use by an operating system or by a hypervisor or container or by a virtual machine or any other virtualized entity. An initial portion of the first storage area is allocated. Swap space events associated with the swap space are detected, at which point the virtualization quality-of-service policies are applied to the swap space event to determine one or more swap space management operations. The determined swap space management operations are executed over the multi-tiered swap space.

### FIELD

This disclosure relates to computing systems, and more particularly to techniques for managing multi-tiered swap space.

### BACKGROUND

Many modern computing systems can implement numerous virtualized entities (e.g., virtual machines) on a single computing node of a hardware computing appliance. Such virtual machines (VMs) are configured with a certain amount of virtual memory (e.g., 8 GB) to support the respective applications and processes of each of the VMs. The actual physical memory underlying the virtual memory is composed of various memory devices that aggregate to a fixed total physical address space (e.g., 512 GB). To circumvent certain constraints (e.g., a maximum of 64 VM per node) imposed by the sharing of the fixed physical computing node memory over the VMs at the node, various virtual memory paging techniques (e.g., page swapping techniques) can be implemented. Implementation of such paging techniques are facilitated by configuring virtual swap spaces to which a respective VM guest operating system can, for example, swap out the data pages that had been least recently used by the VM.

At the computing node, such virtual swap space is often backed by a memory or storage device that is characterized by a cost and performance level that is lower than that of the memory device backing the virtual memory space. For example, the virtual memory might be backed by a high speed and high cost random access memory (RAM) device (e.g., DDR4 device) and the virtual swap space might be backed by a lower speed and lower cost random access persistent memory (RAPM) device (e.g., Intel Xpoint device). In other cases, the swap device might be an even slower and even less expensive solid state drive device (SSD) or hard disk drive device (HDD).

Unfortunately, the VMs and their guest operating systems are unaware of the one or more types memory devices backing their virtual memory space or virtual swap space. However, the quality of service (e.g., response times, etc.) delivered to the users of the VMs can be greatly affected by the swap device characteristics as well as swap space allocations across the VMs. As an example, a virtual swap space supported by RAPM devices might have high performance, but the cost of such devices may introduce a constraint on the maximum number and/or memory allocation of the VMs at a particular computing node. In contrast, a virtual swap space supported by HDD devices might remove such scaling and/or size constraints, but deliver a low quality of service (e.g., low performance).

Therefore, what is needed is a way to manage virtual swap spaces (e.g., virtual swap spaces of VMs at a computing node) composed of storage facilities formed of multiple types of memory devices and/or storage devices.

### SUMMARY

The present disclosure describes techniques used in systems, methods, and in computer program products for managing multi-tiered swap space, which techniques advance the relevant technologies to address technological issues with legacy approaches. More specifically, the present disclosure describes techniques used in systems, methods, and in computer program products for delivering QoS-based management of multi-tiered swap space in virtual memory systems. Certain embodiments are directed to technological solutions for enforcing quality-of-service policies when determining swap space paging operations between multiple tiers of swap devices.

The disclosed embodiments modify and improve over legacy approaches. In particular, the herein-disclosed techniques provide technical solutions that address the technical problems attendant to delivering a specified quality of service in the presence of a swap space that comprises multiple types of memory and/or storage devices. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of virtual memory computing systems as well as advances in various technical fields related to high-performance computing.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1 depicts a computing environment in which embodiments of the present disclosure can be implemented.

FIG. 2 presents a multi-tiered swap space management technique as implemented in systems that facilitate QoS-based management in virtual memory systems, according to an embodiment.

FIG. 3A is a block diagram of a system for QoS-based management of multi-tiered swap space in virtual memory systems, according to an embodiment.

FIG. 3B illustrates several data structures that are used improve the way a computer stores and retrieves data in memory when performing QoS-based management of multi-tiered swap space in virtual memory systems, according to an embodiment.

FIG. 4 depicts swap space event processing techniques as implemented in systems that facilitate QoS-based management of multi-tiered swap space in virtual memory systems, according to an embodiment.

FIG. 5A depicts a page read event flow as implemented in systems that facilitate QoS-based management of multi-tiered swap space in virtual memory systems, according to an embodiment.

FIG. 5B depicts a page write event flow as implemented in systems that facilitate QoS-based management of multi-tiered swap space in virtual memory systems, according to an embodiment.

FIG. 5C presents an intra-swap paging technique as implemented in systems that facilitate QoS-based management of multi-tiered swap space in virtual memory systems, according to an embodiment.

FIG. 6 illustrates a distributed virtualization environment in which embodiments of the present disclosure can be implemented.

FIG. 7 depicts system components as arrangements of computing modules that are interconnected so as to implement certain of the herein-disclosed embodiments.

FIG. 8A, FIG. 8B, and FIG. 8C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of delivering a specified quality of service to virtual machines in the presence of a swap space that comprises multiple types of memory and/or storage devices. Some embodiments are directed to approaches for enforcing quality-of-service policies when determining swap space paging operations between multiple tiers of swap devices. The accompanying figures and discussions herein present example environments, systems, methods, and computer program products for QoS-based management of multi-tiered swap space in virtual memory systems.

### Overview

Disclosed herein are techniques for accessing virtualization quality-of-service (QoS) policies to determine what swap space management operations are to be performed when there are multiple tiers of data storage devices (e.g., comprising tiers of random access memories, random access persistent memories, and block-oriented swap devices). In certain embodiments, swap space events from one or more sources (e.g., guest operating systems) are received. The swap space events are analyzed to determine various event attributes. One or more of the aforementioned virtualization quality-of-service policies are applied to the event attributes to determine a set of one or more swap space management (e.g., paging) operations. The swap space management operations are executed over the multiple tiers of swap devices. In certain embodiments, the swap space management operations are determined at least in part from historical page access data. In certain embodiments, a particular virtualization QoS policy is accessed to determine swap space management operations between a respective pair of swap devices or between swap tiers. In certain embodiments, the swap space management operations carry out a reallocation of the virtual swap space of a particular VM. In certain embodiments, a particular virtualization QoS policy serves to throttle a first VM by moving its swapped-out pages from a higher-performing tier to a lower-performing tier so that other VMs that share the same set of tiers of swap space can use the higher-performing swap space. In certain embodiments, the swap devices are managed by a hypervisor and include one or more RAPM devices, one or more SSD devices, and one or more HDD devices.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

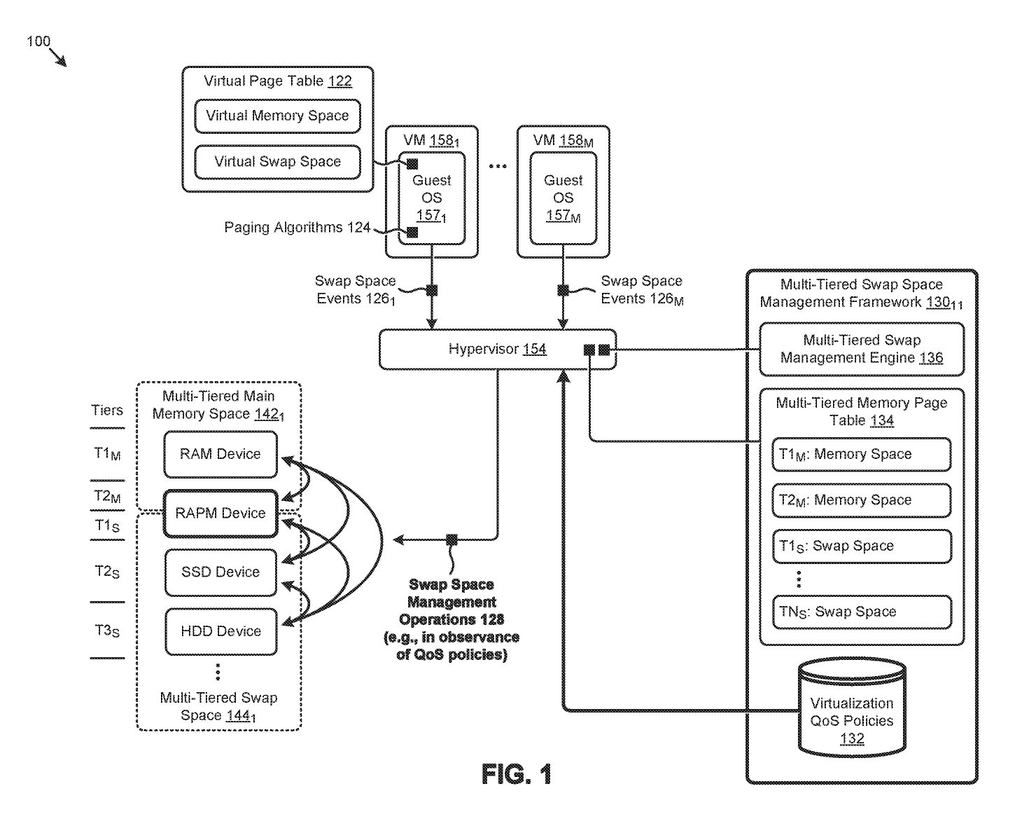

FIG. 1 depicts a computing environment 100 in which embodiments of the present disclosure can be implemented. As an option, one or more variations of computing environment 100 or any aspect thereof may be implemented in the context of the architecture and functionality of the embodiments described herein.

FIG. 1 illustrates one aspect pertaining to enforcing quality-of-service policies when determining swap space paging operations between multiple tiers of swap devices. Specifically, the figure is presented to illustrate a framework to address the problem of delivering a specified quality of service in the presence of a swap space that comprises multiple types of memory devices and/or storage devices.

As shown, computing environment 100 comprises a plurality of virtual machines (e.g., VM 158₁, . . . , VM 158_{M}) that can represent any virtualized entity in the computing environment 100. Each of the VMs comprises a respective guest operating system (e.g., guest OS 157₁, . . . , guest OS 157_{M}) that interacts with a hypervisor 154. As an example, the VMs and hypervisor can be implemented on a single computing node of a hardware computing appliance. The VMs are configured with a certain amount of virtual memory space to support the respective applications and processes of each of the VMs. To facilitate paging techniques at the VMs, virtual swap spaces are also allocated to the VMs. As can be observed, guest OS 157₁ of VM 158₁ accesses a virtual page table 122 to manage the virtual memory space and the virtual swap space of VM 158₁. Paging between the virtual memory space and the virtual swap space at VM 158₁ might be in accordance with certain instances of paging algorithms 124 (e.g., LRU algorithm) at guest OS 157₁.

The actual physical memory underlying the virtual memory is composed of various memory devices that aggregate to a fixed total physical address space (e.g., 512 GB). To overcome certain constraints (e.g., a maximum of 64 VM per node) imposed by the sharing of a fixed amount of physical computing node memory over the VMs at the node, various virtual memory paging techniques (e.g., page swapping techniques) can be implemented. Implementation of such paging techniques are facilitated by configuring multiple tiers of virtual swap spaces between which an underlying guest operating system can, for example, swap out little-used data pages.

The virtual memory space and virtual swap space of the VMs are backed by one or more memory or storage devices. For example, the physical memory or storage devices might consist of the physical devices of the computing node that is hosting the VMs. More specifically, and as shown in computing environment 100, the various virtual memory spaces might be backed by a multi-tiered main memory space 142₁ composed of storage areas of RAM devices and a first portion of a RAPM device. The VM's virtual swap spaces might be backed by a multi-tiered swap space 144₁ composed of storage areas of a second portion of a RAPM device, an SSD device, an HDD device, and/or other memory or storage devices.

The tiers of the multi-tiered main memory space 142₁ (e.g., T1_{M} and T2_{M}) and the tiers of the multi-tiered swap space 144₁ (e.g., T1_{S}, T2_{S}, and T3_{S}) are often characterized by a respective memory cost and performance level. For example, tier T1_{M} corresponds to a high speed and high cost RAM device (e.g., DDR4 device), while tier T2_{M} corresponds to a lower speed and lower cost RAPM device (e.g., Intel Xpoint device). The tiers comprising the swap space are also distinguished by the cost and performance of the memory or storage devices associated with the tiers. Such varying performance over the multi-tiered main memory space 142₁ and/or multi-tiered swap space 144₁ can greatly affect the quality of service (e.g., response times, etc.) delivered to the users of the VMs.

The herein disclosed techniques address issues attendant to delivering a specified quality of service in the presence of a swap space that comprises multiple types of memory and/or storage devices. Specifically, some embodiments implement a multi-tiered swap space management framework 130ii to facilitate the herein disclosed techniques.

In the embodiment of FIG. 1, the multi-tiered swap space management framework 130₁₁ can comprise a multi-tiered swap management engine 136 and a multi-tiered memory page table 134 implemented at hypervisor 154, and a data store of virtualization QoS policies 132. The multi-tiered swap management engine 136 detects certain swap space events (e.g., swap space events 126₁ from guest OS 157₁ and/or swap space events 126_{M} from guest OS 157_{M}) such as page read-write events or page fault events. One or more of the virtualization QoS policies 132 are applied to the event attributes describing the detected swap space events to determine a set of swap space management operations 128. The swap space management operations 128 are executed over the multi-tiered main memory space 142₁ and/or the multi-tiered swap space 144₁.

Virtualization QoS policies are allocation or reallocation rules or constraints that are applied to different virtualized entities in a virtualization system. The different virtualized entities can be hosted by a virtualization system provider that supports sharing of virtualized swap space areas by any number of virtualized entities. The aforementioned virtualization rules or constraints are used to determine how and/or when a portion of swap space in a first tier should be considered for movement to a second tier so as to allow the virtualization system to support more VMs. As such, the movement can be from a higher tier to a lower tier, or the movement can be from a lower tier to a higher tier. The application of a virtualization QoS policy over a then-current set of computing system conditions often results in the determination of one or more swap space management operations 128, which swap space management operations, if implemented in the computing system, serve to improve the functioning (e.g., performance or cost-effectiveness) of the system as a whole.

As used herein, the aforementioned virtualization policies and/or its constituent rules and/or constraints are referred to as virtualization QoS policies or QoS policies. As used herein, a swap space management operation is an action taken over one or more devices that host swap space. In some cases, a swap space management operation invokes a copy of at least some data from one swap space device to another swap space device. In some cases, a swap space management operation invokes a copy of at least some data from one swap area to another swap space area. Such a copy operation might be implemented as a move operation, where the original source of the data on a device is deleted or marked for deletion or merely marked as available for other uses.

As illustrated, the swap space management operations might invoke specific paging operations within the multi-tiered main memory space 142₁, between the multi-tiered main memory space 142₁ and the multi-tiered swap space 144₁ (e.g., page-in operations, page-out operations, etc.), and/or within the multi-tiered swap space 144₁ (e.g., intra-swap paging operations). The multi-tiered memory page table 134 of the multi-tiered swap space management framework 130₁₁ is a specialized data structure to facilitate tracking of data pages over the multiple tiers of main memory space and multiple tiers of swap space.

One embodiment of a technique for multi-tiered swap space management as facilitated by the multi-tiered swap space management framework 130₁₁ is disclosed in further detail as follows.

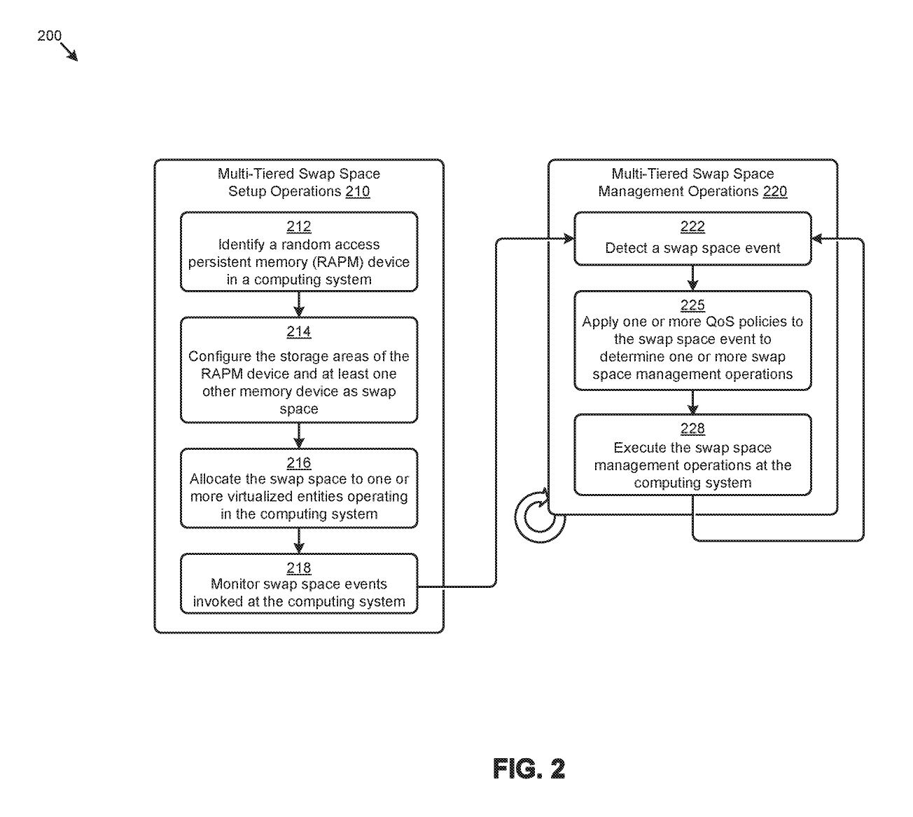

FIG. 2 presents a multi-tiered swap space management technique 200 as implemented in systems that facilitate QoS-based management in virtual memory systems. As an option, one or more variations of a multi-tiered swap space management technique 200 or any aspect thereof may be implemented in the context of the architecture and functionality of the embodiments described herein. The multi-tiered swap space management technique 200 or any aspect thereof may be implemented in any environment.

The multi-tiered swap space management technique 200 presents one embodiment of certain steps and/or operations that facilitate enforcement of quality-of-service policies when determining swap space paging operations between multiple tiers of swap devices. As shown, a first portion of the steps and/or operations comprise a set of multi-tiered swap space setup operations 210, and a second portion of the steps and/or operations comprise a set of multi-tiered swap space management operations 220. The multi-tiered swap space setup operations 210 can commence by identifying at least one random access persistent memory device in a computing system (step 212). In some cases, a tier of random access persistent memory comprises multiple random access persistent memory devices. In other cases, one or more tiers of random access persistent memory might comprise multiple random access persistent memory devices of different speeds, and/or from different manufacturers.

The storage areas of the RAPM device and at least one other memory device are configured as swap space (step 214). For example, a configuring a swap space might comprises allocating a portion of the storage areas of the RAPM device a T2_{S} swap space and allocating a portion of a hard disk drive device to a T3_{S} swap space.

The swap space is then allocated to one more virtualized entities (e.g., VMs) operating in the computing system (step 216). In some cases, the swap space is equally apportioned to the one or more virtualized entities in the computing system. However, in some situations, the swap space demand of a particular virtual machine can be known a priori. In such situations a virtual machine that has an a priori known high demand for swap space might receive a relatively larger portion of the total swap space as compared to other virtualized entities in the computing system. The computing system is then monitored for any swap space events pertaining to the swap space (step 218).

The multi-tiered swap space management operations 220 can commence by detecting a swap space event (step 222). For example, the swap space event might be invoked by the virtualized entities or other components of the computing system. A swap space event is often an event in a computing system that affects the swap space of the system. A swap space event is often an event that affects the relative apportionments of swap space between different types of swap space devices of the system. The swap space event can be described by various event attributes. The event attributes can be codified and/or communicated using various techniques such as by communicating signals over a bus, encoding or referring to an event attribute via a CPU instruction, encoding or referring to an event attribute via an operating system command, and/or encoding or referring to an event attribute using other types of programming objects.

Responsive to detecting the swap space event, one or more QoS policies are applied to the swap space event to determine one or more swap space management operations (step 225). Strictly as examples, any one or more of the QoS policies might refer to characteristics of the multi-tiered main memory space 142₁, and/or characteristics of the multi-tiered swap space 144₁ (e.g., pertaining to relative speeds of page-in operations, page-out operations, etc.), and/or any one or more of the QoS policies might refer to characteristics of intra-swap paging operations.

The swap space management operations are then executed at the computing system (step 228). The swap space management operations include, but are not limited to, page-out operations (e.g., when a page in a higher performance RAM tier is moved to a lower performance tier), page-in operations (e.g., when a page in a lower-performance tier is moved to a higher performance RAM or RAPM tier), or intra-swap paging operations (e.g., when a page in a more fully in-use tier is moved to a less fully in-use tier).

One embodiment of a system for implementing the multi-tiered swap space management technique 200 and/or other herein disclosed techniques is disclosed as follows.

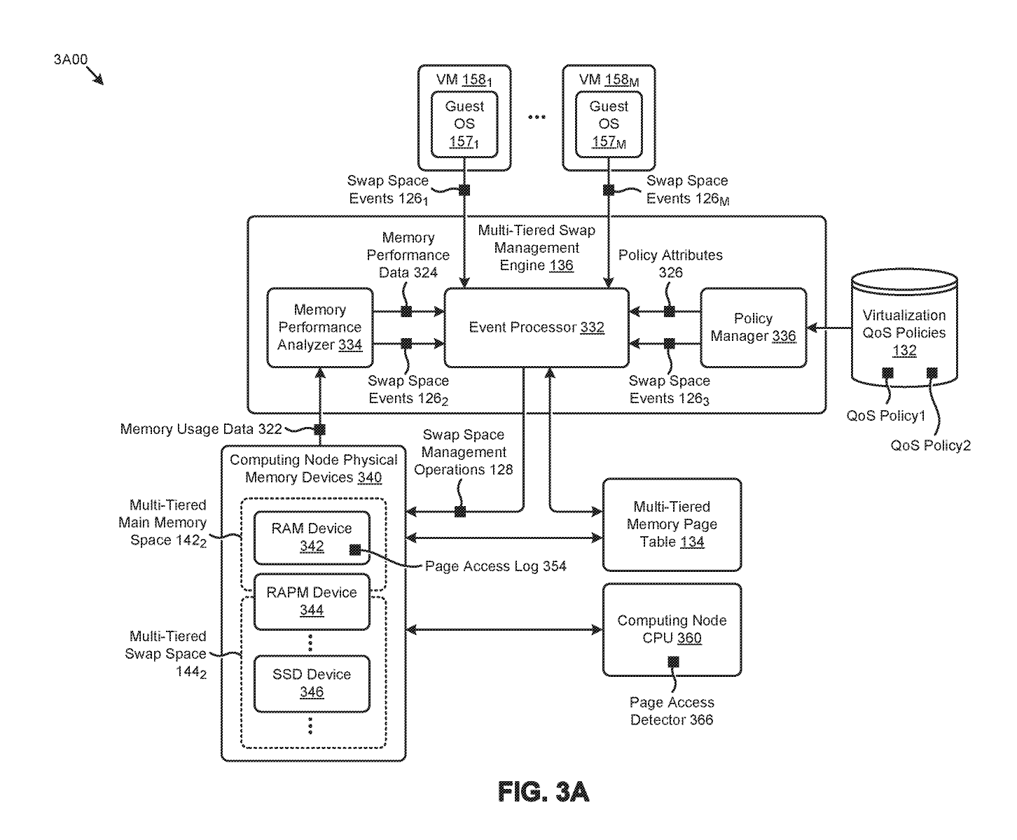

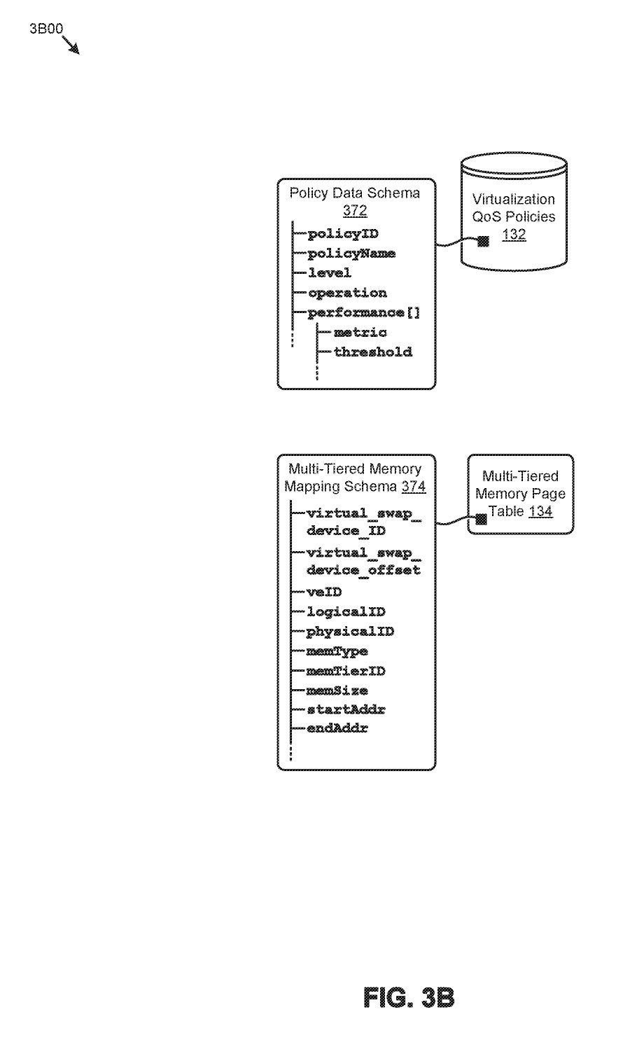

FIG. 3A is a block diagram of a system 3A00 for QoS-based management of multi-tiered swap space in virtual memory systems. As an option, one or more variations of system 3A00 or any aspect thereof may be implemented in the context of the architecture and functionality of the embodiments described herein. The system 3A00 or any aspect thereof may be implemented in any environment.

FIG. 3A illustrates one aspect pertaining to enforcing quality-of-service policies when determining swap space paging operations between multiple tiers of swap devices. Specifically, the figure is being presented to show one embodiment of the components and associated data flows that facilitate QoS-based management of multi-tiered swap space in virtual memory systems. The components and data flows shown in FIG. 3A present one partitioning and associated data manipulation approach. The specific example shown is purely exemplary, and other subsystems, data structures, and/or partitionings are reasonable.

As shown, the system of FIG. 3A presents an instance of multi-tiered swap management engine 136, a multi-tiered memory page table 134, and instances (e.g., QoS policy1, QoS policy2) of the QoS policies 132 earlier described. The guest OS 157₁ of VM 158₁ and the guest OS 157_{M} of VM 158_{M} are also shown. The allocation of swap space areas of a VM, and/or resulting or predictable performance characteristics of one or more VMs in a system may be changed by applying a QoS policy. For example, if a first VM has an allocation of a large amount of swap space in a higher tier (e.g., higher-performing tier), but that VM is not actively using the pages in that higher tier, then some or all of the large amount of swap space in the higher tier might be moved to a lower tier (e.g., lower-performing tier), thus freeing-up space in the higher tier, which freed-up space can be used by a different VM.

A QoS policy such as QoS Policy1 can be expressed in language such as “Move swapped-out pages from a higher tier to swapped-out pages in a lower tier when the pages in the higher tier are not being frequently accessed”. Such a description can be codified into a machine-readable policy statement and/or into specific rules and/or specific constraints. Strictly as one example, a rule might be expressed as, “Move a swapped-out page from tier1 to a swapped-out page in tier2 when the page in the tier1 has not been accessed for 1 second or more”. Other policy statements and/or specific rules and/or specific constraints pertain to movement from a lower tier to a higher tier. In some cases, a rule might derive from different characteristics of the devices that underlie a tier. For example, a rule might be expressed as, “Move a swapped-out page from SSD of tier3 to a page in RAPM of tier2 whenever the page in the tier3 is accessed”.

Various example use cases, as well as various systems, devices, and techniques to implement QoS policies in such use cases are given as follows. Specifically, system 3A00 comprises a computing node CPU 360 and a set of computing node physical memory devices 340 that are used for implementing the aforementioned QoS techniques. As shown, certain portions of the storage areas of the devices that comprise the computing node physical memory devices 340 are configured into a multi-tiered main memory space 142₂ and a multi-tiered swap space 144₂. Specifically, the multi-tiered main memory space 142₂ is composed of selected storage areas of a RAM device 342 and a RAPM device 344, and the multi-tiered swap space 144₂ is composed of selected storage areas of a RAPM device 344, an SSD device 346, and/or other memory or storage devices.

According to the herein disclosed techniques, various swap space events are detected at an event processor 332 of the multi-tiered swap management engine 136. As earlier described, swap space events 126₁ and swap space events 126_{M} might be invoked by guest OS 157₁ and guest OS 157_{M}, respectively. A set of swap space events 126₂ might also be invoked by a memory performance analyzer 334 of the multi-tiered swap management engine 136. For example, a set of memory usage data 322 received by memory performance analyzer 334 might indicate that a particular swap device has breached a certain device's memory usage threshold and therefore invokes a swap space event to reduce the memory usage of the device. A set of swap space events 126₃ might also be invoked by a policy manager 336 of the multi-tiered swap management engine 136. As an example, the policy manager 336 might detect a change to one or more of the QoS policies 132 and therefore invokes a swap space event to rebalance the multi-tiered swap space 144₂ based on the changed policy information.

At least some of the swap space events received at event processor 332 are analyzed subject to one or more of the QoS policies 132 to determine a set of swap space management operations 128 to execute over the multi-tiered main memory space 142₂ and/or the multi-tiered swap space 144₂. In some cases, a set of policy attributes 326 describing the QoS policies 132 are accessed to determine the swap space management operations 128. The policy attributes 326 describe various information (e.g., a target memory access performance level) associated with a particular policy. A set of memory performance data 324 might also be accessed to determine the swap space management operations 128. The memory performance data 324 describe various performance information (e.g., theoretical or measured access latencies) associated with the memory devices comprising the computing node physical memory devices 340.

The policy attributes 326 (e.g., a target memory access performance level) and the memory performance data 324 (e.g., measured access latencies) can be used, for example, to determine a target swap tier for a “page-out” swap space event. In some cases, the memory performance data 324 might include information pertaining to various page access metrics, such as a page access count. Such page access counts might be stored in a page access log 354 at RAM device 342 for access by the memory performance analyzer 334. In certain embodiments, the page access log 354 might be populated by a page access detector 366 at the computing node CPU 360.

Further details regarding general approaches for use of page access logs, and general approaches for implementing a page access detector, are described in U.S. application Ser. No. 15/891,751 titled “HARDWARE-ASSISTED PAGE ACCESS TRACKING”, filed on Feb. 8, 2018, which is hereby incorporated by reference in its entirety.

Certain specialized data structures that facilitate the herein disclosed techniques are disclosed in further detail as follows.

FIG. 3B illustrates several data structures 3B00 that are used improve the way a computer stores and retrieves data in memory when performing QoS-based management of multi-tiered swap space in virtual memory systems. As an option, one or more variations of data structures 3B00 or any aspect thereof may be implemented in the context of the architecture and functionality of the embodiments described herein. The data structures 3B00 or any aspect thereof may be implemented in any environment.

FIG. 3B illustrates one aspect pertaining to enforcing quality-of-service policies when determining swap space paging operations between multiple tiers of swap devices. Specifically, the figure is being presented with respect to the contribution of certain data structures to addressing the problem of delivering a specified quality of service in the presence of a swap space that comprises multiple types of memory and/or storage devices. In particular, FIG. 3B illustrates an embodiment of a data structure for organizing and/or storing the data associated with the QoS policies 132, and a data structure for organizing and/or storing the data associated with the multi-tiered memory page table 134.

The data of the QoS policies 132, the multi-tiered memory page table 134, and/or any other data described herein can be organized and/or stored using various techniques. For example, the policy data schema 372 associated with QoS policies 132 indicate that the QoS policy information might be organized and/or stored in a tabular structure (e.g., relational database table) that has rows that relate various policy attributes with a particular policy. As another example, the information might be organized and/or stored in a programming code object that has instances corresponding to a particular policy and properties corresponding to the various attributes associated with the policy. As depicted in policy data schema 372, a data record (e.g., table row or object instance) for a particular policy might describe a policy identifier (e.g., stored in a “policyID” field), a policy name (e.g., stored in a “policyName” field), an organization level at which the policy is to be applied (e.g., stored in a “level” field), an operation type to which the policy is to be applied (e.g., stored in an “operation” field), a list of performance criteria (e.g., stored in a “performance [ ]” object), and/or other policy attributes. As further shown in policy data schema 372, an instance of the “performance [ ]” object might comprise a metric type (e.g., stored in a “metric” field) and a corresponding metric threshold value (e.g., stored in a “threshold” field). As one example, a QoS policy performance metric might be “page faults per second” and the corresponding threshold value might be “2000”.

A multi-tiered memory mapping schema 374 associated with multi-tiered memory page table 134 also indicates that the memory page table information might be organized and/or stored in a tabular structure (e.g., relational database table) that has rows that map various physical memory attributes with a particular virtual address of a virtualized entity. As another example, the information might be organized and/or stored in a programming code object that has instances corresponding to a particular virtual address of a virtualized entity, and properties corresponding to the physical memory corresponding to the virtual address. As depicted in multi-tiered memory mapping schema 374, a data record (e.g., table row or object instance) for a particular virtual address might be described using a device ID (e.g., via the shown “virtual_swap_device_ID” field) and an offset (e.g., “virtual_swap_device_offset” field). The combination of the device ID and a corresponding offset uniquely describes a starting location of a page or range of pages. The multi-tiered memory mapping schema 374 might include variations that depend, at least in part, on the nature of the underlying computing system and/or its constituent components. Strictly as examples, some variations include a virtualized entity identifier (e.g., stored in a “veID” field), a logical memory device identifier (e.g., stored in a “logicalID” field), a physical memory device identifier (e.g., stored in a “physicalID” field), a memory type (e.g., “swap” stored in a “memType” field), a memory tier identifier (e.g., stored in a “memTierID” field), a memory size (e.g., stored in a “memSize” field), a block or portion start address (e.g., stored in a “startAddr” field), a block or portion end address (e.g., stored in a “endAddr” field), and/or other memory mapping attributes. Variations of the multi-tiered memory mapping schema may include more or fewer of the shown fields. Certain variations may include more or fewer (or different) fields and/or certain variations may employ any one or more of the aforementioned fields having different semantics.

The foregoing discussions describe techniques for processing detected swap space events, which techniques are disclosed in further detail as follows.

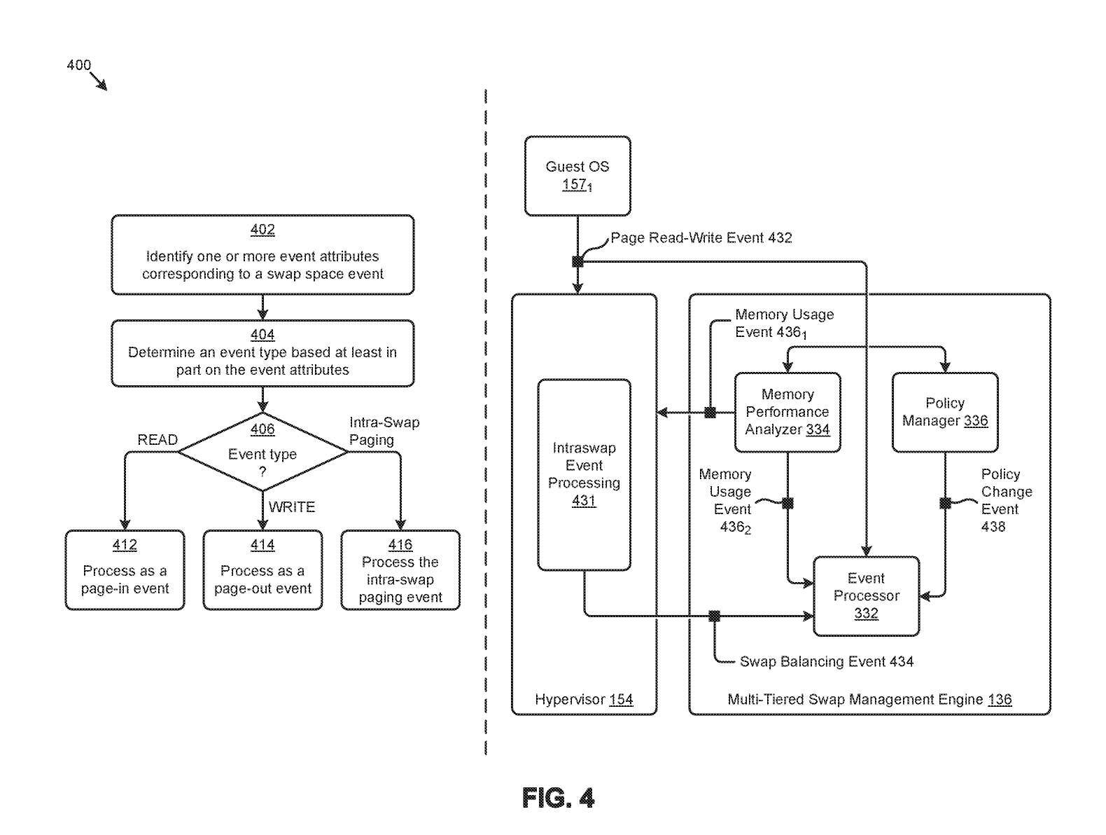

FIG. 4 depicts swap space event processing techniques 400 as implemented in systems that facilitate QoS-based management of multi-tiered swap space in virtual memory systems. As an option, one or more variations of the swap space event processing techniques 400 or any aspect thereof may be implemented in the context of the architecture and functionality of the embodiments described herein. The swap space event processing techniques 400 or any aspect thereof may be implemented in any environment. FIG. 4 illustrates one aspect pertaining to enforcing quality-of-service policies when determining swap space paging operations between multiple tiers of swap devices.

Specifically, the figure is being presented with respect to its contribution to processing swap space events that might invoke such swap space paging operations. The swap space event processing techniques presents one embodiment of certain steps and/or operations that process the swap space events. Various components earlier described are also presented in FIG. 4 to illustrate possible uses of the swap space event processing techniques 400.

The swap space event processing techniques 400 can commence by identifying one or more event attributes corresponding to a swap space event (step 402). An event type is determined based at least in part on the event attributes (step 404). If the swap space event is a page-in event (see “Page In” path of decision 406), then the swap space event is processed as a page-in event (step 412). If the swap space event is a page-out event (see “Page Out” path of decision 406), then the swap space event is processed as a page-out event (step 414). If the swap space event is an intra-swap paging event (see “Intra-Swap Paging” path of decision 406), then the swap space event is processed as an intra-swap paging event (step 416). Other event types and associated processing steps are possible.

As illustrated in FIG. 4, event processor 332 might detect a page read-write event 432 invoked by guest OS 157₁.

If an event attribute of the page read-write event 432 refers to a READ (e.g., of page that is not in main memory), the page read-write event 432 will be processed as a page-in event. If the event attribute of the page read-write event 432 refers to a WRITE, then the page read-write event 432 will be processed as a page-out event.

A listener might be included in conjunction with a policy manager 336. If a policy change event 438 detected by the listener or by the policy manager 336, and that policy change event 438 corresponds to an aspect of swap space performance, then an intra-swap paging event might be raised (e.g., to balance between different areas of swap space). As a specific example of such processing, a memory usage event 436₁ from the memory performance analyzer 334 might invoke intra-swap event processing 431 in the hypervisor 154, and the hypervisor in turn might raise a swap balancing event 434 to be processed by the event processor 332. Additionally, a memory usage event 436₂ from the memory performance analyzer 334 may be processed by the event processor without going through the hypervisor. Any of the aforementioned event types can raise signals or messages that include any number or forms of event attributes that describe respective memory devices and respective usage metrics.

As can be appreciated, any of the various processing entities (e.g., hypervisors, memory performance analyzers, policy managers, etc.) can manage any number and/or forms of block storage devices. Moreover, such processing entities are free to use any underlying devices and/or techniques to provide pages to a guest OS or VM. More specifically, the hypervisors, memory performance analyzers, policy managers, etc. are free to manage pages using any configurations or apportionments of RAPM, SSD, HDD, etc. In such situations, the guest operating systems produce page read-write events that are agnostic to and/or unaware of underlying devices, and/or configurations and/or apportionments of swap spaces.

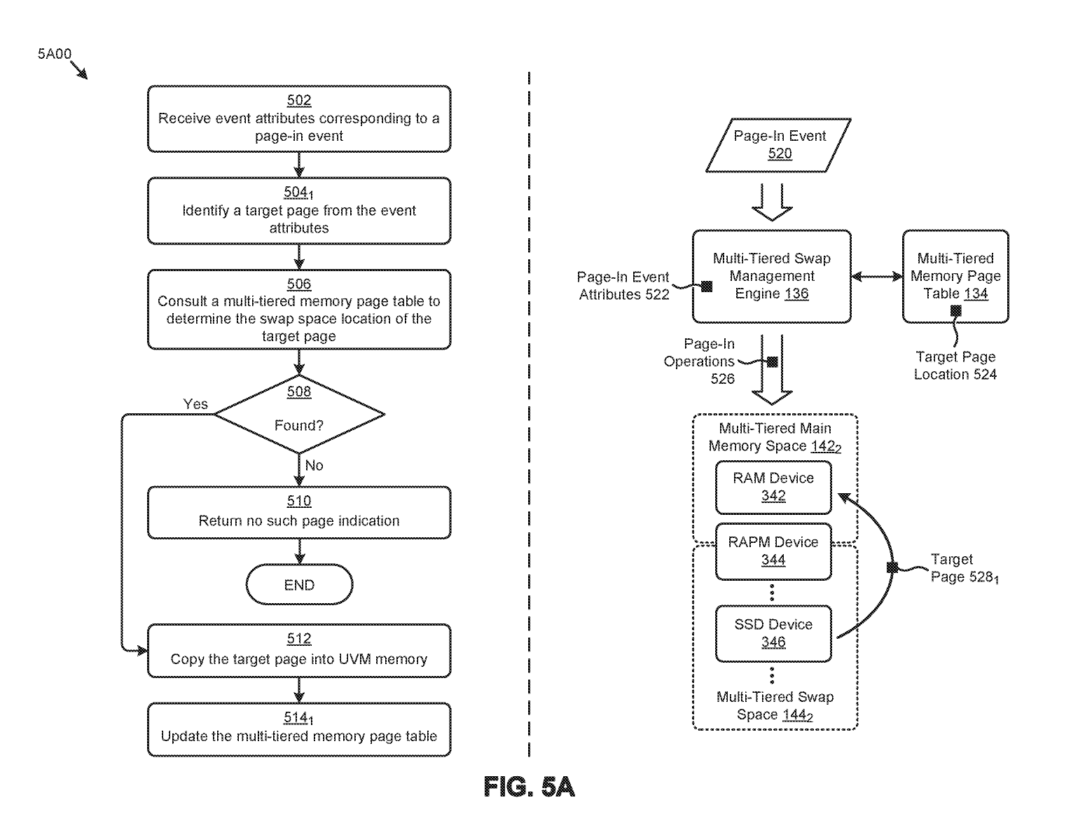

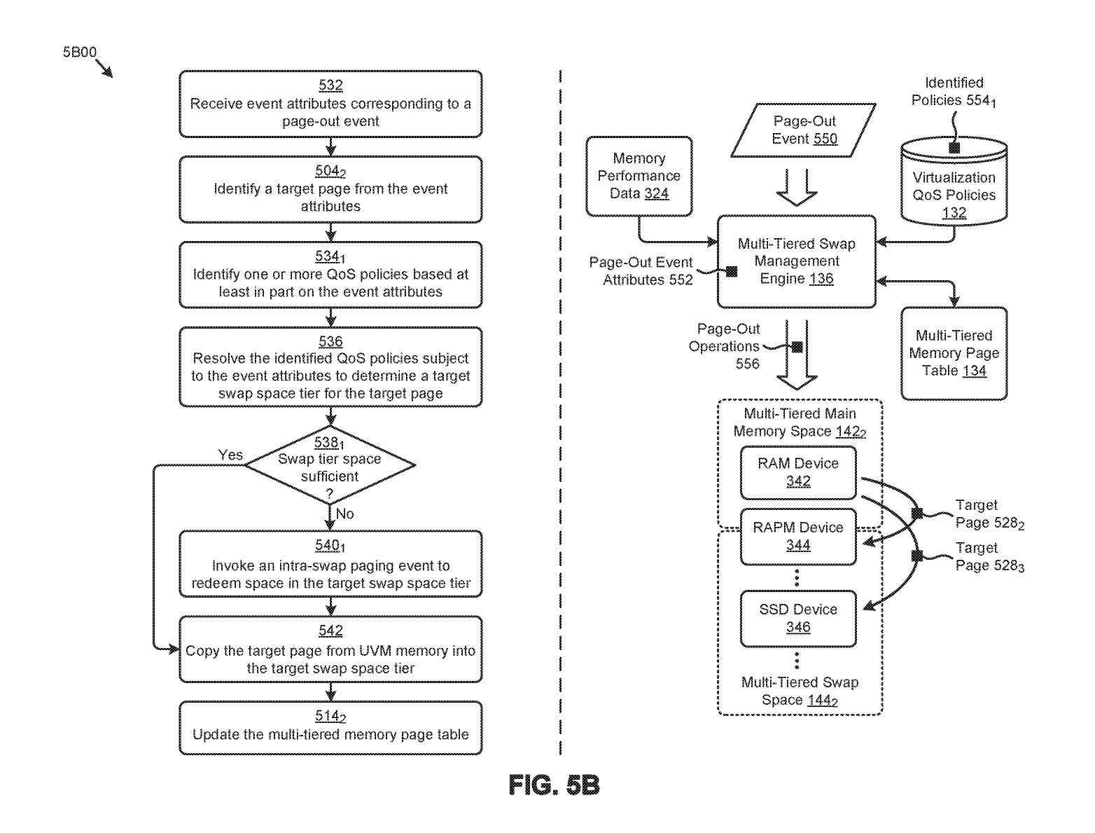

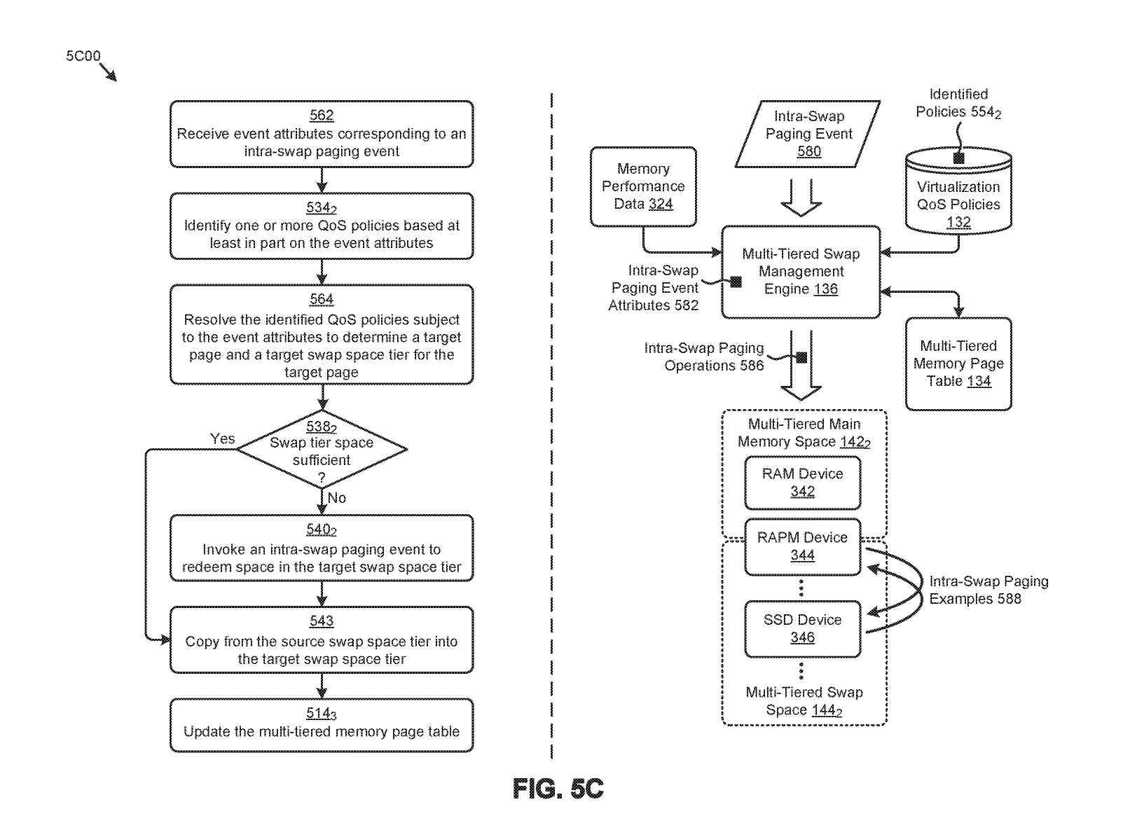

Examples of page read-write events and their processing are disclosed in further detail as pertains to the page read event flow of FIG. 5A and as pertains to the page write event flow FIG. 5B.

FIG. 5A depicts a page read event flow 5A00 as implemented in systems that facilitate QoS-based management of multi-tiered swap space in virtual memory systems. As an option, one or more variations of page read event flow 5A00 or any aspect thereof may be implemented in the context of the architecture and functionality of the embodiments described herein. The page read event flow 5A00 or any aspect thereof may be implemented in any environment.

FIG. 5A illustrates one aspect pertaining to enforcing quality-of-service policies when determining swap space paging operations between multiple tiers of swap devices. Specifically, the figure is being presented with respect to its contribution to processing page-in events pertaining to a multi-tiered swap space. The page read event flow 5A00 presents one embodiment of certain steps and/or operations that process such page-in events.

Various components earlier described are also presented in FIG. 5A to illustrate operation of the page read event flow 5A00. The components include the multi-tiered swap management engine 136, the multi-tiered memory page table 134, the multi-tiered main memory space 142₂ composed of selected storage areas of a RAM device 342 and a RAPM device 344, and the multi-tiered swap space 144₂ composed of selected storage areas of a RAPM device 344, an SSD device 346, and/or other memory or storage devices.

As shown, the page read event flow 5A00 commences by receiving event attributes corresponding to a page-in event (step 502). For example, the multi-tiered swap management engine 136 might receive a set of page-in event attributes 522 from a page-in event 520. A target page corresponding to the page-in event is identified from the event attributes (step 504₁). A multi-tiered memory page table is then consulted to determine the swap space location of the target page (step 506). The swap space location can be determined by a lookup into a multi-tiered memory page table to identify the swap device (e.g., by the value of field “virtual_swap_device_ID”) and offset (e.g., by the value of the “virtual_swap_device_offset”). Referring to the specific embodiment and environment of FIG. 5A, the multi-tiered swap management engine 136 consults such a multi-tiered memory page table 134 to discover a target page location 524 of a target page 528₁.

If the page is not found, the “No” path of decision 508 is taken and a “no such page” indication is returned (step 510). In some cases, a response to a “no such page” occurrence results in returning a page or pages filled with zeros.

On the other hand, if the page is found in the swap space, then the “Yes” path of decision 508 is taken and the target page is copied to the virtual memory space of the caller (step 512). As an example, the target page 528₁ that is copied into virtual memory space of a UVM might be copied-up from the SSD device 346 to the RAM device 342. The multi-tiered memory page table is then updated according to the new physical storage location of the target page (step 514₁).

The paging in of the target page (e.g., page-in operations 526), the updating of the multi-tiered memory page table, and/or other operations, comprise the swap space management operations of the shown multi-tiered swap management engine 136.

FIG. 5B depicts a page write event flow 5B00 as implemented in systems that facilitate QoS-based management of multi-tiered swap space in virtual memory systems. As an option, one or more variations of page write event flow 5B00 or any aspect thereof may be implemented in the context of the architecture and functionality of the embodiments described herein. The page write event flow 5B00 or any aspect thereof may be implemented in any environment.

FIG. 5B illustrates one aspect pertaining to enforcing quality-of-service policies when determining swap space paging operations between multiple tiers of swap devices. Specifically, the figure is being presented with respect to its contribution to processing page-out events pertaining to a multi-tiered swap space. The page write event flow 5B00 presents one embodiment of certain steps and/or operations that process such page-out events.

Various components earlier described are also presented in FIG. 5B to illustrate operation of the page write event flow 5B00. The components include the multi-tiered swap management engine 136, the QoS policies 132, the multi-tiered memory page table 134, the memory performance data 324, the multi-tiered main memory space 142₂ composed of selected storage areas of a RAM device 342 and a RAPM device 344, and the multi-tiered swap space 144₂ composed of selected storage areas of the RAPM device 344, an SSD device 346, and/or other memory or storage devices.

The page write event flow 5B00 can commence by receiving event attributes corresponding to a page-out event (step 532). For example, the multi-tiered swap management engine 136 might receive a set of page-out event attributes 552 from a page-out event 550. A target page corresponding to the page-out event is identified from the event attributes (step 504₂). A multi-tiered memory page table 134 is consulted to determine the device ID and offset corresponding to the target page.

One or more QoS policies are identified based at least in part on the event attributes (step 534₁). For example, a set of identified policies 554₁ might be selected from the QoS policies 132. The identified QoS policies are resolved subject to the event attributes to determine a target swap space tier for the target page (step 536). For example, certain performance criteria specified in the identified policies 554₁ might be compared to corresponding performance measurements from the memory performance data 324 to determine that the swap space tier served by the RAPM device 344 is the target swap space tier. The device ID as was determined by the aforementioned access to the multi-tiered memory page table can be used in the determination of QoS policies and/or for determination of actions to take based on then-present conditions and/or history.

Continuing, if the available space in the target swap space tier (e.g., the swap space of RAPM device 344) is not sufficient (see “No” path of decision 538₁), then an intra-swap paging event is invoked to redeem space in the target swap space tier (step S401). Processing of intra-swap paging events according to the herein disclosed techniques is described in more detail as pertains to FIG. 5C.

When there is sufficient space for the target page in the target swap space tier (see “Yes” path of decision 538₁), then the target page is copied from the UVM memory into the target swap space tier (step 542). As an example, the target page 528₂ of a UVM might be determined to be copied from the RAM device 342 to the swap space portion of the RAPM device 344. Such a determination can be made based on characteristics of the identified QoS policies. In another example, the target page 528₃ might be determined to be swapped-out from the RAM device 342 to the SSD device 346. Such a determination can be made based on characteristic of the identified QoS policies. For example, such a determination might be made based on a history or time analysis of that page that indicates the page is rarely accessed. Page access counts and/or histories might be stored in a page access in a RAM device for access by the memory performance analyzer.

The multi-tiered memory page table 134 is then updated according to the new physical storage location of the target page (step 514₂). The paging out of the target page, the paging out of one or more pages to provide space for the target page, the updating of the multi-tiered memory page table, and/or other operations, comprise the swap space management operations (e.g., page-out operations 556) generated in response to the received page-out event 550.

The foregoing discussions include techniques for processing intra-swap paging events, which techniques are disclosed in further detail as follows.

FIG. 5C presents an intra-swap paging technique 5C00 as implemented in systems that facilitate QoS-based management of multi-tiered swap space in virtual memory systems. As an option, one or more variations of intra-swap paging technique 5C00 or any aspect thereof may be implemented in the context of the architecture and functionality of the embodiments described herein. The intra-swap paging technique 5C00 or any aspect thereof may be implemented in any environment.

FIG. 5C illustrates one aspect pertaining to enforcing quality-of-service policies when determining swap space paging operations between multiple tiers of swap devices. Specifically, the figure is being presented with respect to its contribution to processing intra-swap paging events pertaining to a multi-tiered swap space. The intra-swap paging technique 5C00 presents one embodiment of certain steps and/or operations that process such intra-swap paging events.

Various components earlier described are also presented in FIG. 5C to illustrate operation of the intra-swap paging technique 5C00. The components include the multi-tiered swap management engine 136, the QoS policies 132, the multi-tiered memory page table 134, the memory performance data 324, the multi-tiered main memory space 142₂ composed of selected storage areas of a RAM device 342 and a RAPM device 344, and the multi-tiered swap space 144₂ composed of selected storage areas of the RAPM device 344, an SSD device 346, and/or other memory or storage devices.

The intra-swap paging technique 5C00 can commence by receiving event attributes corresponding to an intra-swap paging event (step 562). For example, the multi-tiered swap management engine 136 might receive a set of intra-swap paging event attributes 582 from an intra-swap paging event 580. One or more QoS policies are identified based at least in part on the event attributes (step 434₂). For example, a set of identified policies 554₂ might be selected from the QoS policies 132. The identified QoS policies are resolved subject to the event attributes to determine a target page and a target swap space tier for the target page (step 564). For example, certain performance criteria specified in the identified policies 554₂ might be compared to corresponding performance measurements from the memory performance data 324 to identify a target page that is to be moved from a first swap space tier to a second swap space tier.

If the available space in the target swap space tier is not sufficient (see “No” path of decision 538₂), then an intra-swap paging event is invoked to redeem space in the target swap space tier (step 540₂). The determination of the characteristics of an intra-swap paging event can be determined based on the QoS policies and/or based on then-present conditions and/or history.

When there is sufficient space for the target page in the target swap space tier (see “Yes” path of decision 538₂), then the target page is copied from source swap space tier into the target swap space tier (step 543). As shown in the intra-swap paging examples 588, a target page might be swapped from the SSD device 346 to the swap space portion of the RAPM device 344, or a target page might be swapped from the swap space portion of the RAPM device 344 to the SSD device 346. The multi-tiered memory page table 134 is then updated according to the new physical storage location of the target page (step 514₃). The paging of the target page, the paging out of one or more pages to provide space for the target page, the updating of the multi-tiered memory page table, and/or other operations, comprise the swap space management operations (e.g., intra-swap paging operations 586) generated in response to the received intra-swap paging event 580.

In certain embodiments, the swap space management operations determined by the herein disclosed techniques might include adjusting the portion of swap space allocated to a virtualized entity. For example, if a VM is initially allocated 4 GB of virtual swap space, but uses no more than 2 GB (e.g., as indicated by certain memory performance data), then the swap space allocation associated with the VM might be gradually reduced over time (e.g., from 4 GB to 3.5 GB, and from 3.5 GB to 3 GB).

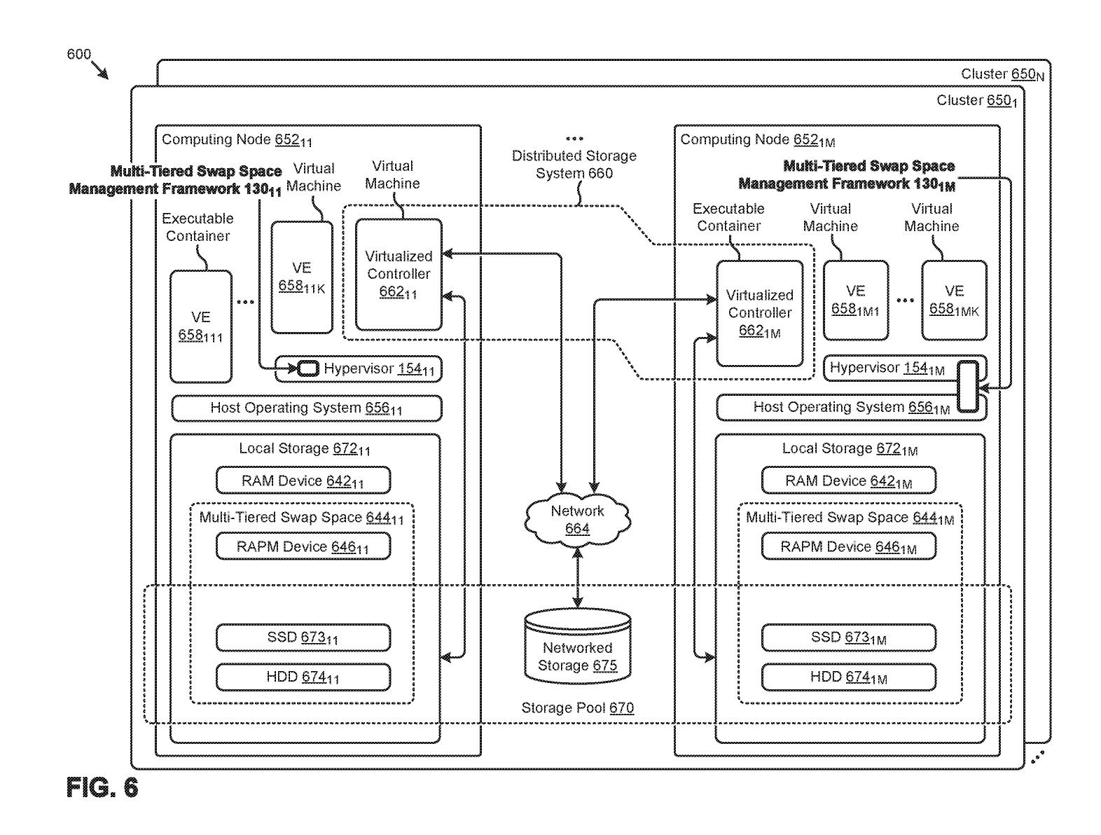

An example of a distributed computing environment (e.g., distributed virtualization environment, etc.) that supports any of the herein disclosed techniques is presented and discussed as pertains to FIG. 6.

FIG. 6 illustrates a distributed virtualization environment 600 in which embodiments of the present disclosure can be implemented. As an option, one or more variations of distributed virtualization environment 600 or any aspect thereof may be implemented in the context of the architecture and functionality of the embodiments described herein.

The shown distributed virtualization environment depicts various components associated with instances of distributed virtualization systems (e.g., hyperconverged distributed systems) that can be used to implement the herein disclosed techniques. Specifically, the distributed virtualization environment 600 comprises multiple clusters (e.g., cluster 650₁, . . . , cluster 650_{N}) comprising multiple nodes that have multiple tiers of storage in a storage pool. Representative nodes (e.g., node 652₁₁, . . . , node 652_{1M}) and storage pool 670 associated with cluster 650₁ are shown. Each node can be associated with one server, multiple servers, or portions of a server. The nodes can be associated (e.g., logically and/or physically) with the clusters. As shown, the multiple tiers of storage include storage that is accessible through a network 664, such as a networked storage 675 (e.g., a storage area network or SAN, network attached storage or NAS, etc.). The multiple tiers of storage further include instances of local storage (e.g., local storage 672₁₁, . . . , local storage 672_{1M}). For example, the local storage can be within or directly attached to a server and/or appliance associated with the nodes. Such local storage can include solid state drives (SSD 673₁₁, . . . , SSD 673_{1M}), hard disk drives (HDD 674₁₁, . . . , HDD 674_{1M}), and/or other storage devices. As further shown, memory storage at the nodes can also include RAM devices (RAM device 642₁₁, . . . , RAM device 642_{1M}), RAPM devices (RAPM device 646₁₁, . . . , RAPM device 646_{1M}), and/or other intra-node block-addressable devices. In certain embodiments, one or more of the RAPM devices, one or more of the SSD devices, and/or one or more of the HDD devices can compose a multi-tiered swap space (e.g., multi-tiered swap space 644₁₁, . . . , multi-tiered swap space 644_{1M}), according to the herein disclosed techniques.

As shown, any of the nodes of the distributed virtualization environment 600 can implement one or more user virtualized entities (e.g., VE 658₁₁₁, VE 658_{11K}, . . . , VE 658_{1M1}, . . . , VE 658_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 656₁₁, . . . , host operating system 656_{1M}), while the VMs run multiple applications on various respective guest operating systems. Such flexibility can be facilitated at least in part by a hypervisor (e.g., hypervisor 154₁₁, . . . , hypervisor 154_{1M}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 656₁₁, . . . , host operating system 656_{1M}) without, in most cases, a hypervisor layer. This lightweight implementation can facilitate efficient distribution of certain software components, such as applications or services (e.g., micro-services). Any node of a distributed virtualization environment 600 can implement both a hypervisor-assisted virtualization environment and a container virtualization environment for various purposes. Also, any node in a distributed virtualization environment can implement a virtualized controller to facilitate access to storage pool 670 by the VMs and/or containers.

As used in these embodiments, a virtualized controller is a collection of software instructions that serve to abstract details of underlying hardware or software components from one or more higher-level processing entities. A virtualized controller can be implemented as a virtual machine, as a container (e.g., a Docker container), or within a layer (e.g., such as a layer in a hypervisor).

Multiple instances of such virtualized controllers can coordinate within a cluster to form the distributed storage system 660 which can, among other operations, manage the storage pool 670. This architecture further facilitates efficient scaling in multiple dimensions (e.g., in a dimension of computing power, in a dimension of storage space, in a dimension of network bandwidth, etc.).

The foregoing virtualized controllers can be implemented in the distributed virtualization environment using various techniques. As one specific example, an instance of a virtual machine at a given node can be used as a virtualized controller in a hypervisor-assisted virtualization environment to manage storage and I/O (input/output or IO) activities. In this case, for example, the virtualized entities at node 652₁₁ᵢ can interface with a controller virtual machine (e.g., virtualized controller 662₁₁) through hypervisor 154₁₁ to access the storage pool 670. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 660. For example, a hypervisor at one node in the distributed storage system 660 might correspond to VMware ESXi software, and a hypervisor at another node in the distributed storage system 660 might correspond to Nutanix AHV software. As another virtualized controller implementation example, containers (e.g., Docker containers) can be used to implement a virtualized controller (e.g., virtualized controller 662_{1M}) in an operating system virtualization environment at a given node. In this case, for example, the virtualized entities at node 652_{1M} can access the storage pool 670 by interfacing with a controller container (e.g., virtualized controller 662_{1M}) through hypervisor 154_{1M} and/or the kernel of host operating system 656_{1M}.

As earlier described, the problems attendant to delivering a specified quality of service in the presence of a swap space that comprises multiple types of memory and/or storage devices can be addressed in the context of the foregoing environment. Moreover, any aspect or aspects of enforcing quality-of-service policies when determining swap space paging operations between multiple tiers of swap devices can be implemented in the context of the foregoing environment. Specifically, in certain embodiments, one or more instances of a multi-tiered swap space management framework can be implemented over any of the components in the distributed virtualization environment 600 to facilitate the herein disclosed techniques. Specifically, multi-tiered swap space management framework 130₁₁ can be implemented in one or more hypervisors (e.g., hypervisor 154₁₁) of node 652₁₁, and multi-tiered swap space management framework 130_{1M} can be implemented in one or more hypervisors (e.g., hypervisor 154_{1M}) and/or host operating system 656_{1M} of node 652_{1M}. Such instances of the multi-tiered swap space management framework can be implemented in any node in any cluster. Actions taken by one or more instances of the multi-tiered swap space management framework can apply to a node (or between nodes), and/or to a cluster (or between clusters), and/or between any resources or subsystems accessible by the multi-tiered swap space management framework, the virtualized controllers, and/or their agents.

### Additional Embodiments of the Disclosure

### Additional Practical Application Examples

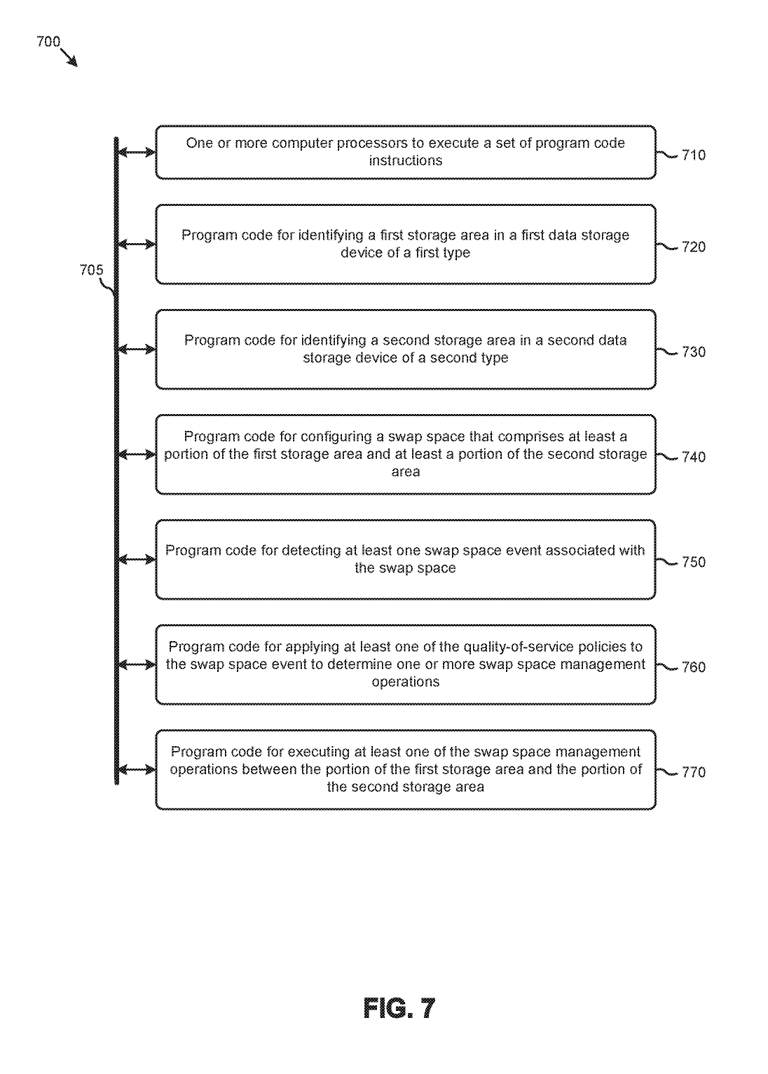

FIG. 7 depicts a system 700 as an arrangement of computing modules that are interconnected so as to operate cooperatively to implement certain of the herein-disclosed embodiments. This and other embodiments present particular arrangements of elements that, individually and/or as combined, serve to form improved technological processes that address problems with delivering a specified quality of service in the presence of a swap space that comprises multiple types of memory and/or storage devices. The partitioning of system 700 is merely illustrative and other partitions are possible.

As an option, the system 700 may be implemented in the context of the architecture and functionality of the embodiments described herein. Of course, however, the system 700 or any operation therein may be carried out in any desired environment. The system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims.

The shown embodiment implements a portion of a computer system including an executable portion of a hypervisor and/or an executable portion of an operating system. The presented system 700, comprises one or more computer processors to execute a set of program code instructions (module 710) and modules for accessing memory to hold program code instructions to perform: identifying a first storage area in a first data storage device of a first type (module 720); identifying a second storage area in a second data storage device of a second type (module 730); configuring a swap space that comprises at least a portion of the first storage area and at least a portion of the second storage area (module 740); detecting at least one swap space event associated with the swap space (module 750); applying at least one of the quality-of-service policies to the swap space event to determine one or more swap space management operations (module 760); and executing at least one of the swap space management operations between the portion of the first storage area and the portion of the second storage area (module 770).

Variations of the foregoing may include more or fewer of the shown modules. Certain variations may perform more or fewer (or different) steps and/or certain variations may use data elements in more or in fewer (or different) operations.

### System Architecture Overview

### Additional System Architecture Examples

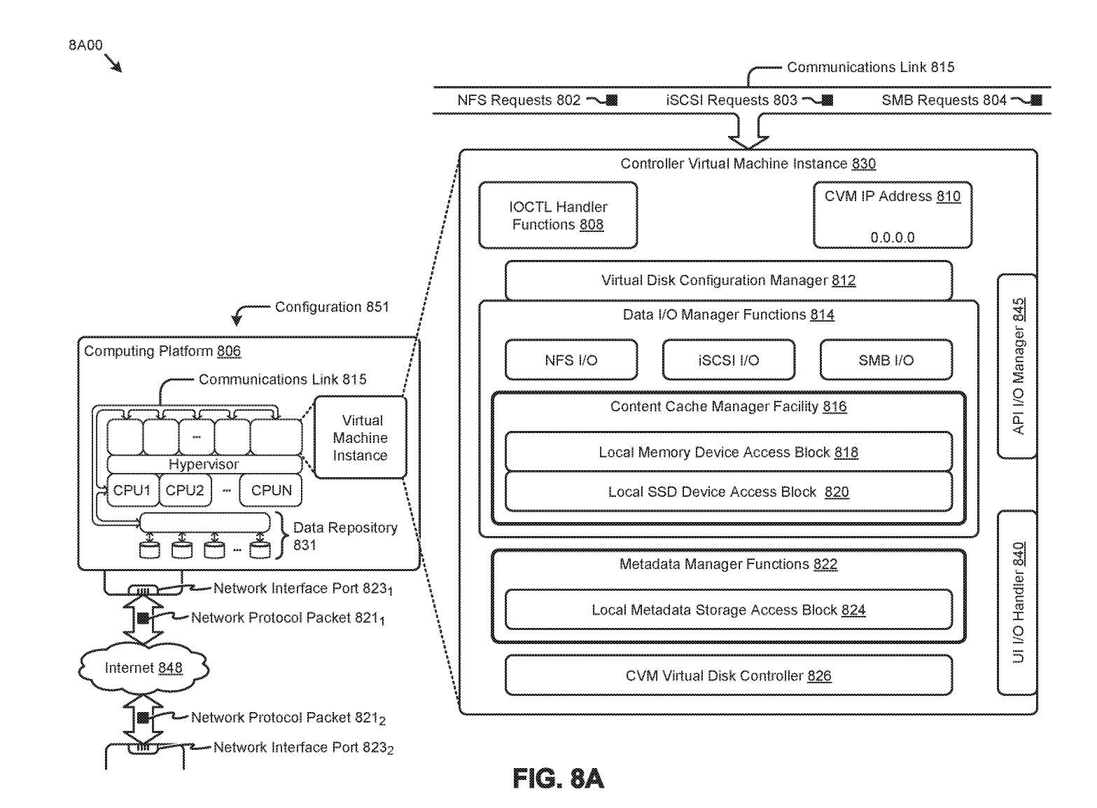

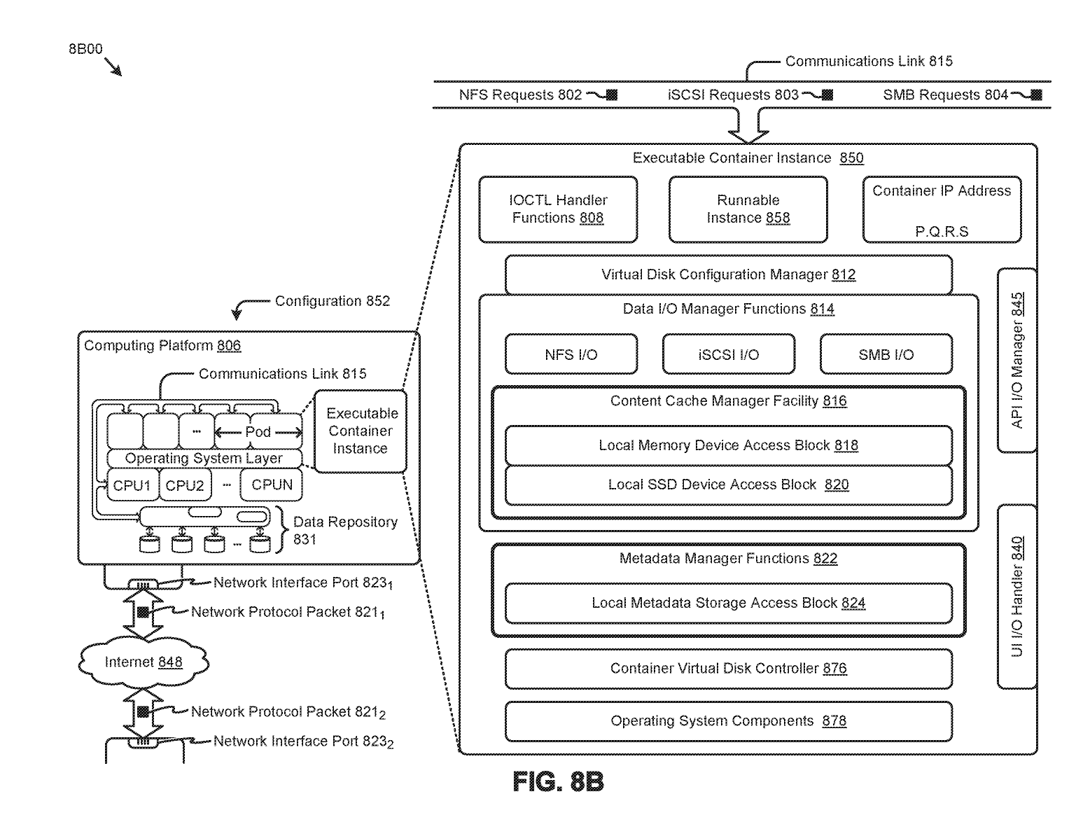

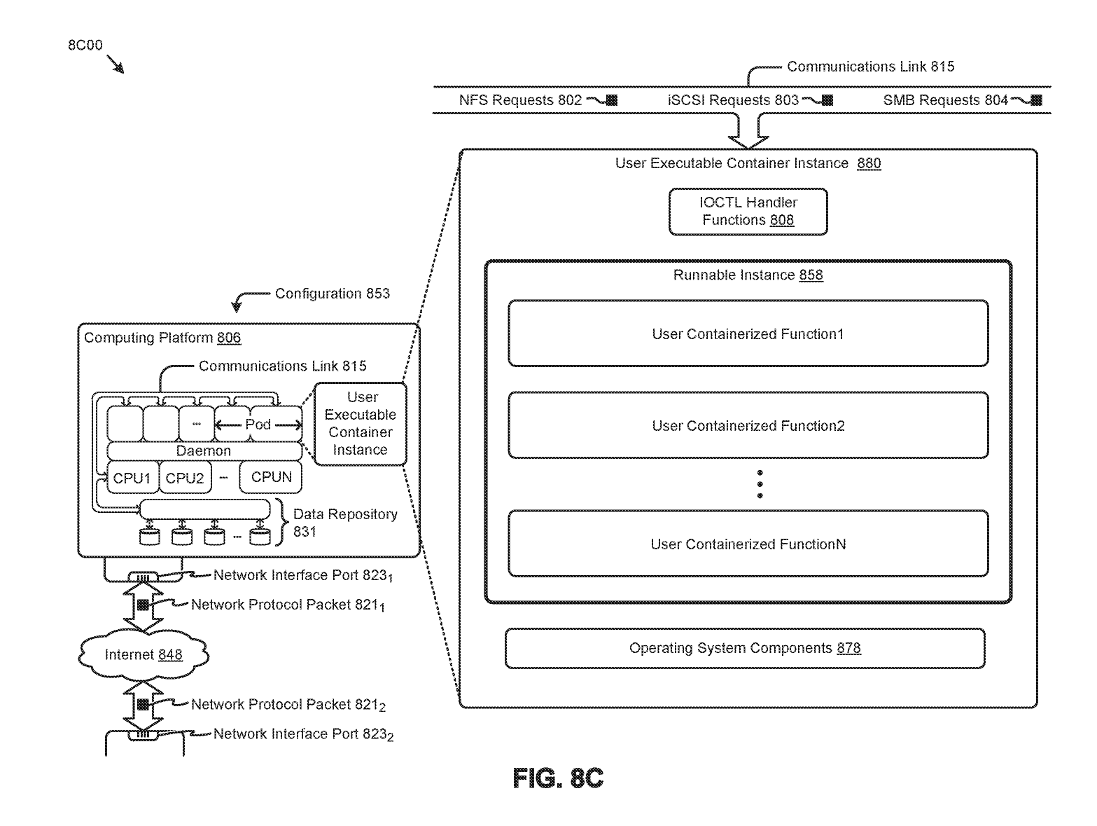

FIG. 8A depicts a virtualized controller as implemented by the shown virtual machine architecture 8A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 830.

In this and other configurations, a controller virtual machine instance receives block I/O (input/output or IO) storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output (I/O or IO) can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 831, which in turn can be formatted into any one or more storage areas, and which can comprise parameterized storage accessible by a key (e.g., a filename, a table name, a block address, an offset address, etc.). External data repository 831 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 824. External data repository 831 can be configured using CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

Computing platform 806 may transmit and receive messages that can be composed of configuration data and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or the results of executing program code can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to QoS-based management of multi-tiered swap space in virtual memory systems. In some embodiments, a module may include one or more state machines and/or combinational logic used to implement or facilitate the operational and/or performance characteristics pertaining to QoS-based management of multi-tiered swap space in virtual memory systems.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of QoS-based management of multi-tiered swap space in virtual memory systems). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to QoS-based management of multi-tiered swap space in virtual memory systems, and/or for improving the way data is manipulated when performing computerized operations pertaining to enforcing quality-of-service policies when determining swap space paging operations between multiple tiers of swap devices.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls-a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 880. Configuration 853 includes a daemon layer (as shown) that performs certain functions of an operating system.

User executable container instance 880 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 880.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for applying virtualization quality-of-service policies to manage a multi-tiered swap space, the method performed by at least one processor and comprising:
identifying a first storage area in a first data storage device of a first type;
identifying a second storage area in a second data storage device of a second type;
configuring a swap space that comprises at least a portion of the first storage area and at least a portion of the second storage area;
allocating an initial portion of the first storage area to a first virtualized entity;
detecting at least one swap space event associated with the swap space;
applying at least one of the virtualization quality-of-service policies to the swap space event to determine one or more swap space management operations; and
executing at least one of the swap space management operations between the portion of the first storage area and the portion of the second storage area.

2. The method of claim 1, further comprising:
applying at least one of the of the virtualization quality-of-service policies to one or more event attributes to determine at least one of the swap space management operations.

3. The method of claim 1, further comprising:
updating a multi-tiered memory page table based at least in part on the swap space management operations.

4. The method of claim 1, further comprising:
reallocating at least a portion of the swap space to the first virtualized entity; and
adjusting allocation of the swap space pertaining to a second virtualized entity.

5. The method of claim 1, further comprising:
accessing a set of memory performance data; and
determining at least one of the swap space management operations, wherein the determining is based at least in part on at least a portion of the set of memory performance data.

6. The method of claim 1, wherein the swap space management operations comprise at least one of, a page-out operation, a page-in operation, or an intra-swap paging operation.

7. The method of claim 1, wherein the swap space event is invoked by at least one of, a page read-write event, a swap balancing event, a memory usage event, or a policy change event.

8. The method of claim 1, wherein at least one of the swap space management operations are determined based at least in part on a first characteristic of a first swap space tier and a second characteristic of a second swap space tier.

9. The method of claim 1, wherein the first data storage device is a random access persistent memory device (RAPM device).

10. The method of claim 1, wherein the second data storage device is a solid state drive device, or a hard disk drive device.

11. The method of claim 1, further comprising detecting a change to one or more of the virtualization quality-of-service policies.

12. The method of claim 11, further comprising invoking at least one swap space event in response to the detecting the change to the one or more of the virtualization quality-of-service policies.

13. A computer readable medium, embodied in a non-transitory computer readable medium, the non-transitory computer readable medium having stored thereon a sequence of instructions which, when stored in memory and executed by one or more processors causes the one or more processors to perform a set of acts for applying virtualization quality-of-service policies to manage a multi-tiered swap space, the acts comprising:
identifying a first storage area in a first data storage device of a first type;
identifying a second storage area in a second data storage device of a second type;
configuring a swap space that comprises at least a portion of the first storage area and at least a portion of the second storage area;
allocating an initial portion of the first storage area to a first virtualized entity;
detecting at least one swap space event associated with the swap space;
applying at least one of the virtualization quality-of-service policies to the swap space event to determine one or more swap space management operations; and
executing at least one of the swap space management operations between the portion of the first storage area and the portion of the second storage area.

14. The computer readable medium of claim 13, further comprising instructions which, when stored in memory and executed by the one or more processors causes the one or more processors to perform acts of:
applying at least one of the of the virtualization quality-of-service policies to one or more event attributes to determine at least one of the swap space management operations.

15. The computer readable medium of claim 13, further comprising instructions which, when stored in memory and executed by the one or more processors causes the one or more processors to perform acts of:
updating a multi-tiered memory page table based at least in part on the swap space management operations.

16. The computer readable medium of claim 13, further comprising instructions which, when stored in memory and executed by the one or more processors causes the one or more processors to perform acts of:
reallocating at least a portion of the swap space to the first virtualized entity; and
adjusting allocation of the swap space pertaining to a second virtualized entity.

17. The computer readable medium of claim 13, further comprising instructions which, when stored in memory and executed by the one or more processors causes the one or more processors to perform acts of:
accessing a set of memory performance data; and
determining at least one of the swap space management operations, wherein the determining is based at least in part on at least a portion of the set of memory performance data.

18. The computer readable medium of claim 13, wherein the swap space management operations comprise at least one of, a page-out operation, a page-in operation, or an intra-swap paging operation.

19. A system for applying virtualization quality-of-service policies to manage a multi-tiered swap space, the system performed by at least one processor and comprising:
a storage medium having stored thereon a sequence of instructions; and
one or more processors that execute the instructions to cause the one or more processors to perform a set of acts, the acts comprising,
identifying a first storage area in a first data storage device of a first type;
identifying a second storage area in a second data storage device of a second type;
configuring a swap space that comprises at least a portion of the first storage area and at least a portion of the second storage area;
allocating an initial portion of the first storage area to a first virtualized entity;
detecting at least one swap space event associated with the swap space;
applying at least one of the virtualization quality-of-service policies to the swap space event to determine one or more swap space management operations; and
executing at least one of the swap space management operations between the portion of the first storage area and the portion of the second storage area.

20. The system of claim 19, further comprising:
a further sequence of instructions to update a multi-tiered memory page table based at least in part on the swap space management operations.
